(19) United States
(12) Patent Application Publication
(10) Pub. No.: US 2008/0007046 A1
(43) Pub. Date: Jan. 10, 2008

(54) Multi Size Outlet Box

(76) Inventors: Scott M. Barboza, Dighton, MA (US); Michael A. Moore, Dighton, MA (US)

Correspondence Address: Scott M. Barboza;Michael A. Moore, 1244 Davol St, Fall River, MA, 02720, US

(21) Appl. No.: 11/424,554

(22) Filed: Jun. 16, 2006

(51) Int. Cl. F16L 5/00

(52) U.S. Cl. 285/136.1

(57) ABSTRACT

An air diffuser mounting box having multiple, various size inlet collars joined together with annular shaped sections. Each collar has a groove around its perimeter which facilitates cutting with a knife, and subsequent removal of unneeded collar sections.

### BACKGROUND—FIELD OF INVENTION

This invention relates to outlet boxes used in air distribution systems, more particularly to a multi size arrangement used to accommodate various duct sizes.

### BACKGROUND—DESCRIPTION OF PRIOR ART

Outlet boxes are used in Heating and Air Conditioning systems to connect a grille or register to rigid or flexible ducting. Since ducting is available in different sizes, it is desirable to have an outlet that can accept various sizes. U.S. Pat. No. 3,866,950 to Skoch, et al uses a multiple step collar configuration to receive a variety of air duct sizes. When connecting ducts larger than the smallest collar, the unused portion is removed by cutting radially along a groove of reduced wall thickness. Using a standard utility blade tends to guide the cut along a straight line. This can cause the user to inadvertently cut through the wall portion of the collar section, rendering the collar unusable. Because of the location of these grooves, further reduction of wall thickness (to make cutting easier, and possibly help this problem) would substantially weaken the assembly.

An improvement to this design is described in U.S. Pat. No. 5,109,756 to Barboza, et al. A frustum shaped tear band is used to separate collar sections. This configuration adds strength and rigidity without increasing wall thickness. Although this design is effective, it adds height to the assembly which can be undesirable in confined spaces. Also the required tearing action tends to work well only with certain plastic resins, therefore limiting material selection.

### OBJECTS AND ADVANTAGES

Several objects and advantages of the present invention are:

(a) to provide an improved diffuser box with provisions for adapting to various sized duct openings.
(b) to simplify collar removal, without needing to force the knife blade along an unnatural path.
(c) to simplify collar removal when using a rigid, difficult to tear material.
(c) to achieve easy adaptability, without adding unnecessary height.

Further objects and advantages are to provide a diffuser box assembly which can be easily handled, installed, and produced, to cut costs, and reduce labor. Still further objects and advantages will become apparent from a consideration of the ensuing description and drawings.

### DRAWING FIGURES

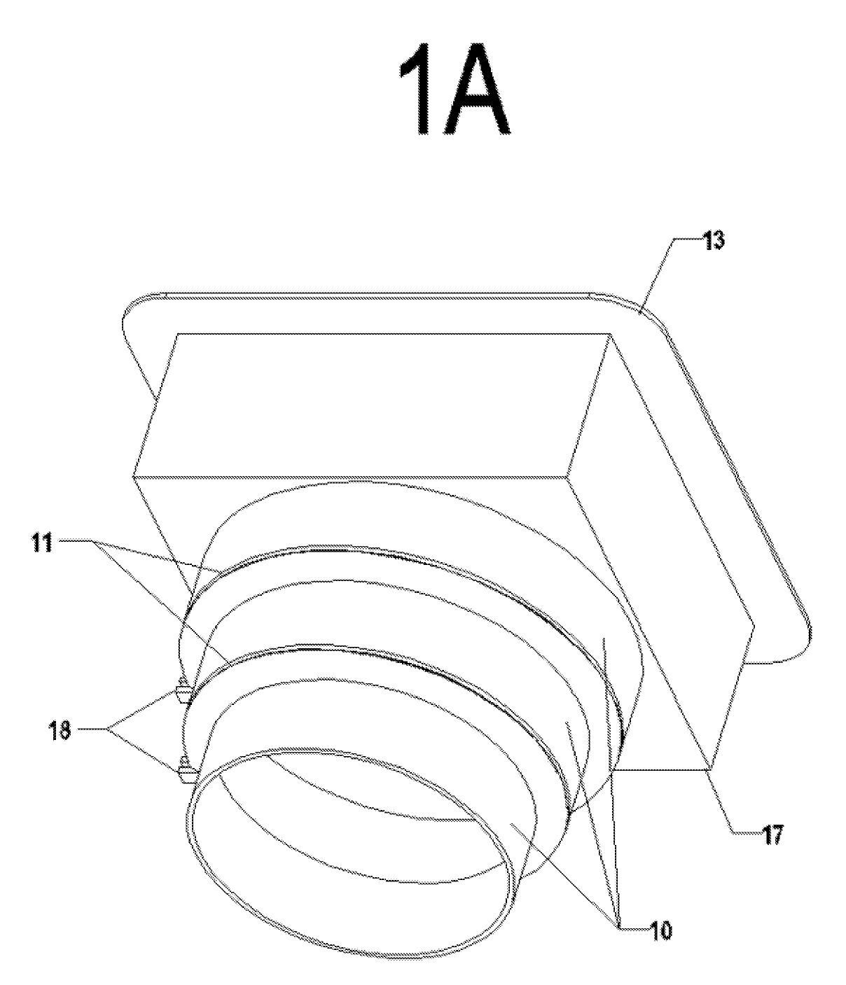

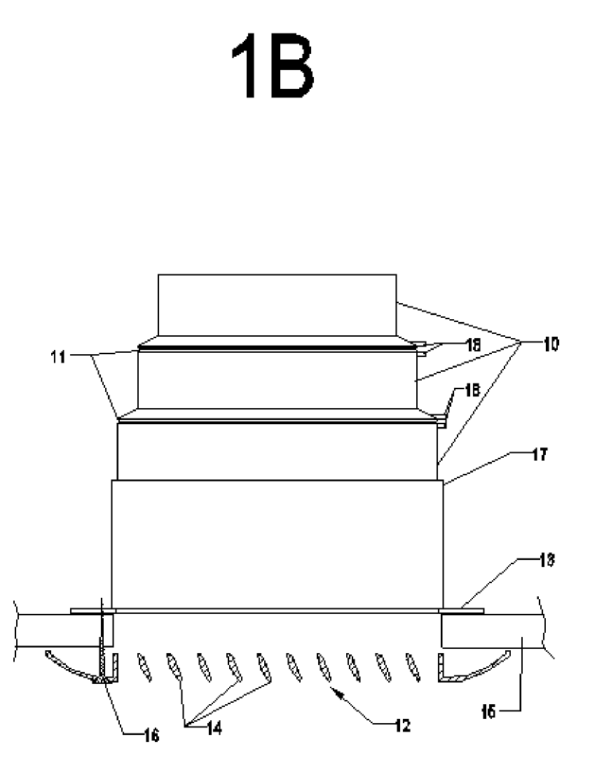

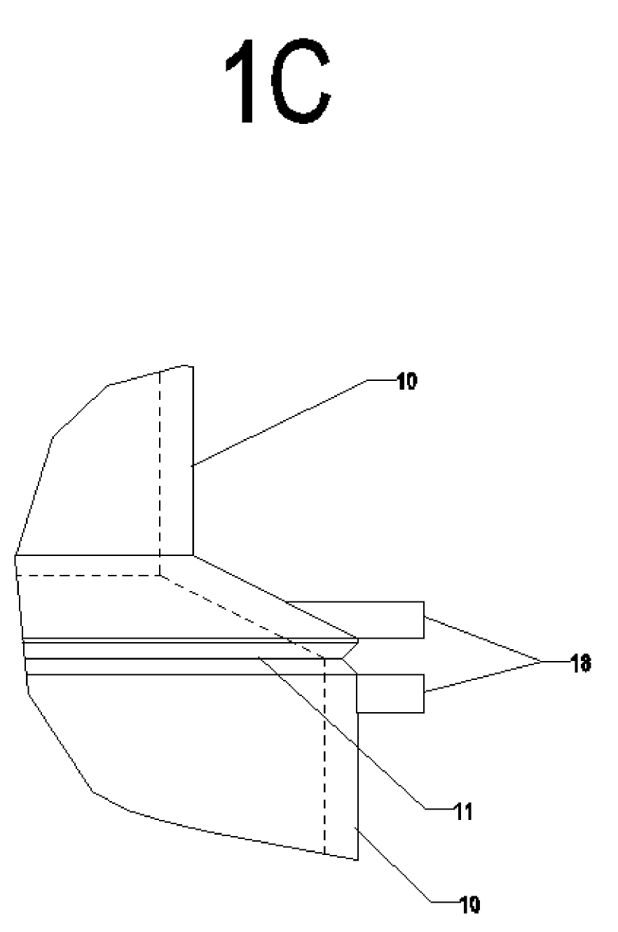

Different views of the invention are shown in FIG. 1A (3D, or isometric view), FIG. 1B (front or elevation view) and FIG. 1C (detail view of groove 11 area).

### REFERENCE NUMERALS IN DRAWINGS

10: collar
11: groove
12: diffuser
13: flange
14: air deflecting fins
15: mounting surface material
16: screw
17: transition area
18: tab

### DESCRIPTION—FIGS. 1A-1C

A plurality of tubular shaped parallel collars 10 of different common duct sizes are arranged in a stepped configuration leaving the largest collar 10 adjacent to the transition area 17.

These collars 10 are of sufficient length to accommodate easy duct installation. Each collar 10 is joined by an annular member 16 which connects collars 10 of different sizes. An alternating series of collars 10 and annular members 34 create the portion of the invention which is to be used for duct connection. V-shaped grooves 12 creating an area of reduced wall thickness are located along the perimeter of collars 10 adjacent to the larger end of the annular members. Located along, and surrounding the groove 11 are multiple separation tabs 18.

The outlet end is of a size, shape, and length to accommodate the insertion of an air grille or diffuser 12.

A flange 13, extending outwardly ninety degrees from and surrounding the outlet end, has a rectangular outer configuration. This flange extends outward to a size slightly less than the overall diffuser 12 size. The diffuser 12 is attached to this flange with a plurality of screws 16. The exact design of the diffuser is not important, but includes a rectangular outer mounting frame, and a plurality of air deflecting fins 14 of sufficient size, quantity, and orientation to direct the exiting air in the desired direction(s).

### OPERATION

The method of installing the present invention, and the function of its parts is described below. After determining the location for the air diffuser FIGS. 1A-1C within a room, a hole, slightly larger than the size of the outlet end, is cut through the mounting surface material 15 (such as gypsum board, plaster, etc.). The invention is placed into the hole, with the inlet, or collar 10 end first, leaving the diffuser 22 opening facing the living space.

After determining the duct size to be connected, all smaller collar 10 sections must be removed to prevent obstruction of the airway. This is done by inserting a sharp knife blade into the v shaped groove, and cutting around the perimeter of collar, thereby removing unneeded sections. An alternate embodiment incorporates a pair of parallel, rectangular shaped tabs 18. A flat blade screwdriver, or similar tool is placed between the tabs 18, and twisted, or rotated. This action initiates the required separation along the groove 11, and eliminates the need to start the cut by piercing with a knife. This method may be more desirable when using stiffer materials. Removal of these unneeded collar 10 sections reveals a beveled edge with a slightly reduced opening diameter. After installing the duct over the collar 10, it may be secured in this position by a strap, clamp, or other suitable means.

It is to be understood, that the above described operation may be performed in an order deemed most convenient to the particular situation.

### SUMMARY, RAMIFICATIONS, AND SCOPE

This invention provides for an improved method of removing unwanted collar sections, with the knife blade guided along a straight line, lowering the chances of accidental injury, damage to the assembly, or significant weakening of the structure.

Although the description above contains many specifities, these should not be construed as limiting the scope of the invention but as merely providing illustrations of some of the preferred embodiments of this invention. For instance the diffuser box assembly can have other shapes such as circular, oval, rectangular etc.

It is claimed:

1. A multi sized outlet box used in air distribution systems comprising:
(a) a plurality of collars, having sufficient size and length to accommodate connection of standard round size air ducts, connected end to end by annular shaped members and,
(b) said collars containing a v shaped groove creating an area of reduced wall thickness, along its outer perimeter

2. The assembly of claim 1 comprising a flange, mounted transversely adjacent to the lower end perimeter to receive diffuser grille.

3. The assembly of claim 1 wherein said flange has an inner and outer rectangular shape.

4. The assembly of claim 1 wherein said groove is situated so as to leave an exposed beveled edge of material after said collar is removed enabling easy installation of said air duct.

5. The assembly of claim 1 comprising a first protrusion located at a point on said collar adjacent to said groove, and a second protrusion located at a point on said annular member and adjacent to said groove and said first protrusion, each protrusion being of sufficient size and shape to accept a screwdriver or prying tool between said protrusions for the purpose of prying apart said protrusions and subsequently initiating a separation of said groove.
